(19) United States
(12) Patent Application Publication
(10) Pub. No.: US 2017/0220570 A1
(43) Pub. Date: Aug. 3, 2017

(54) ADJUSTING MEDIA CONTENT BASED ON COLLECTED VIEWER DATA

(71) Applicant: EchoStar Technologies L.L.C., Englewood, CO (US)

(72) Inventors: Swapnil Anil Tilaye, Superior, CO (US); Nicholas Brandon Newell, Centennial, CO (US)

(73) Assignee: EchoStar Technologies L.L.C.

(21) Appl. No.: 15/008,540

(22) Filed: Jan. 28, 2016

(51) Int. Cl. G06F 17/30; H04N 21/466; H04N 21/45; H04N 21/442

(52) U.S. Cl. CPC G06F 17/30032; G06F 17/30026; G06F 17/3005; H04N 21/44218; H04N 21/4667; H04N 21/4532

(57) ABSTRACT

A system including a media device including a processor programmed to display a first media content item on a display device. The processor is further programmed to collect sensor data during display of first media content item. The data sensor data is related to one or more users determined to be in range to view the display device. The processor is further programmed to select a second media content item based on the sensor data, and insert the second media content item into the display of the first media content item.

### BACKGROUND

The effectiveness of media communications may be increased by aligning the content of the media with the interests of viewers. Additionally, some media content may be inappropriate for certain viewers. Identifying characteristics of viewers at a viewing area, and collecting data indicating the interests of the viewers, permits the customization of media content to a specific group of viewers.

### DRAWINGS

FIG. 1 is a diagram of an exemplary media system for identifying characteristics and interests of viewers and potential viewers of media content.

FIG. 2 is a diagram of an exemplary media device for the media system of FIG. 1.

FIG. 3 is a diagram of an exemplary viewing area, including a camera field of view.

FIG. 4 is a diagram of an exemplary item of media content including three segment locations.

FIG. 5 is an exemplary table of media content segments for the exemplary item of media content of FIG. 4.

FIG. 6 is an exemplary table of media content sub-segments for the exemplary item of media content of FIG. 4, based on a selection of category A from the table of FIG. 5.

FIG. 7 is a diagram of an exemplary process for adjusting an item of media content based on collected data related to the viewers of the item of media content.

### DETAILED DESCRIPTION

### Exemplary System

A media device collects visual and/or audio data related to one or more users at a viewing area, e.g., occupants of a customer premises such as a residence. The collected data may include identity data (body size and shape, facial features, etc.) whereby the media device, using image recognition techniques as are known, can identify the users. The collected data may further include facial expressions, body language, heartrate, eye movement, dilation of pupils, conversations, types of clothing, items (objects, pets, etc.) in possession of the user or arranged in the viewing area, etc., which may be indications of interests and disinterests of the respective users.

The media device stores and maintains the collected data about respective users at the viewing area. The data may include identification of the user based on the identity data, and/or a record of conversations, observed reactions, associated objects, pets, etc. which may indicate interests of the identified user. The media device may further, based on the collected data, make determinations of potential areas of interest and disinterest for the identified user, and store the determined areas of interest and disinterest for the user.

For example, the media device may generate one or more keywords indicating areas of interest of the user. The media device may further generate indicia of interest associated with the keywords. The indicia of interest may be values which indicate a level of interest of the user associated with each of the keyword. The values may be a numeric values between 0 and 100, with 100 being the highest value.

For example, the media device may generate a relatively high indicia of interest for the word Elsa for a particular user, if the user is often heard saying the word Elsa, or is often seen playing with an Elsa doll. As another example, the media device may generate a high indicia of interest for the word Elsa if the word Elsa is heard in an expression such as “Elsa is my favorite character” or “I love Elsa”. As yet another example, the media device may generate a high indicia of interest based on observing a high level of excitement of the user when Elsa is displayed or mentioned in a conversation. In determining an indicia of interest, the media device may give more weight to recently received data, for example, data received during a current viewing event, over previously received data.

The media device may store the keywords together with the indicia of interest. Keywords with higher indicia of interest may be weighted more heavily during the selection of media content for the user.

During the display of a first media content item (e.g., a movie), the media device continues to collect visual and audio data related to the users at the viewing area. The media device makes some determinations as to interests of the respective users based on current data. For example, the media device may determine that the users include children, which may be interested in toys, etc. As another example, by hearing a conversation between two viewers about a football game, the media device may determine that the respective users are interested in football. The media device may assign keywords such as “toys” and “football” to these interests and determine indicia of interest associated with each of the keywords for each user.

In addition to determining interests based on currently collected data, the media device may, based on the identity data, associate one or more of the users with previously stored user data. The media device may thereby retrieve user data for the determination of user interests, and may further add new data to the previously-stored user data.

Based on the determined potential areas of interest, the media device can select a second media content item to be displayed via the media device. The media device may compare, for example, keywords associated with the users with keywords associated with the second media content item. The keywords associated with the second media content item, may be included, e.g., in metadata included in or associated with the second media content item.

The media device, may, for example, select user related keywords with an indicia of interest above a predetermined value, e.g., 70, for selecting the second media content item. During the display of the second media content item, the media device continues to collect data related to the users. Based on user reaction to a segment of the second media content item, the media device may adjust the content of one or more subsequent segments.

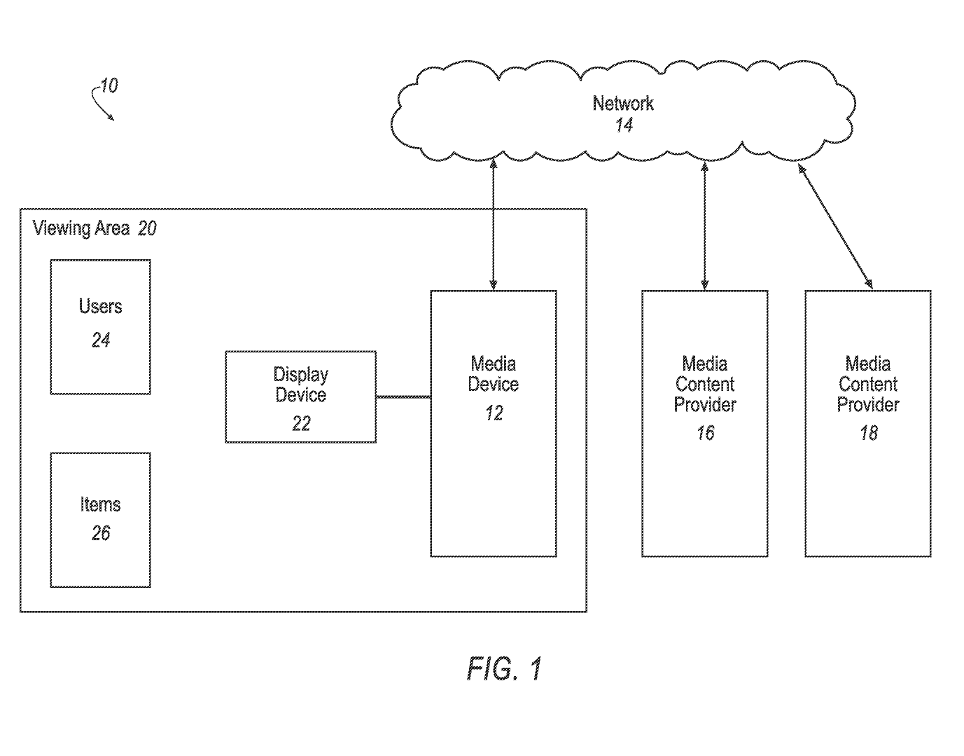

As shown in FIG. 1, an exemplary media system 10 includes a media device 12, network 14, first media content provider 16 and second media content provider 18. The first media content provider 16 may provide, for example, movies, television programming, or other forms of entertainment. The second media content provider 18 may provide, for example, short features such as sports updates, weather updates, documentaries and advertisements. The media device 12 is located in a viewing area 20 and is connected to a display device 22. The media device 12, first media content provider 16 and second media content provider 18 are communicatively coupled, for example, via the network 14.

The viewing area 20 may be, for example, a room in a customer premises such as a home in which the media device 12 and associated display device 22 are located. At different times, one or more users 24 and one or more items 26 may be located in the viewing area 20. As described below, the media device 12 may be associated with one or more data collectors such as cameras, microphones, motion detectors, infrared sensors, ultrasonic sensors, etc. for collecting data regarding users 24 of the viewing area 20.

Users 24 are defined herein as people who are present in the viewing area 20. A viewing event is defined herein as a time during which a first media content item and/or a second media content item is displayed by the media device 12, for example, on the display device 22. For example, the first media content item may be a streamed movie or live broadcast. The second media content item may be a shorter media content item such as an advertisement, infomercial, public service announcement, sports update, weather report, etc. The second media content item may, e.g., be inserted in the first media content item in a particular content location. The content location may be, e.g., a frame number in the first media content item, or for example a time slot such as a time-out or half-time during a live broadcast of a sports event. As described in additional detail below, the media device 12 may collect data regarding the users 24 of the viewing area 20 at one or more times prior to and during a viewing event. Based on the collected data, the media device 12 may select a second media content item, or a segment of the second media content item for display in the content location.

Items 26 include inanimate objects that may be found in the viewing area 20 such as furniture, pictures, articles of clothing, toys, sports equipment, books, trophies, electronic and computing equipment, etc., which may give an indication of interests of the users 24. Items 26 may also include pets detected in the viewing area 20.

The media device 12 provides media content, and is typically a known device such as a set-top box, a laptop, desktop, tablet computer, game box, etc. The term “media content” as used herein, refers to digital audio and/or video data received in a media device 12. The media content may be received, for example, from the media content providers 16, 18 via the network 14.

The network 14 represents one or more mechanisms for providing communications, including the transfer of the first and second media content items, between the media device 12, and the respective first media and second content providers 16, 18. Accordingly, the network 14 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks, local area networks (LAN) and/or wide area networks (WAN), including the Internet, etc.

The first media content provider 16 may be for example, one or more of a cable or satellite television headend, a video streaming service such as generally includes a multimedia web server (or some other computing device), etc. The first media content provider 16 may provide media content, e.g., a movie, live event, audio, to the media device 12. The first media content provider 16 may additionally insert a second media content item into the first media content item.

For example, metadata associated with the first media content item may include indices identifying content locations intended for the insertion of the second media content item. The first media provider 16 computer may search for these indices to determine the intended content location for the second media content item. The second media content item may be inserted directly into the first media content item, or indirectly, for example by accessing a link or the like providing an address of the second media content provider 18 on the network 14.

The media content is typically delivered as compressed audio and/or video data. For example, the data may be formatted according to known standards such as MPEG or H.264. MPEG refers to a set of standards generally promulgated by the International Standards Organization/International Electrical Commission Moving Picture Experts Group (MPEG). H.264 refers to a standard promulgated by the International Telecommunications Union (ITU). Accordingly, by way of example and not limitation, media content may be provided to a media device 12 in a format such as the MPEG-1, MPEG-2 or the H.264/MPEG-4 Advanced Video Coating standards (AVC) (H.264 and MPEG-4 at present being consistent), HEVC/H.265. As is known, MPEG and H.264 data include metadata, audio, and video components. Further, media content and advertisement content in the media system 10 could alternatively or additionally be provided according to some other standard or standards. For example, media content and advertisement content could be audio data formatted according to standards such as MPEG-2 Audio Layer III (MP3), Advanced Audio Coding (AAC), etc.

The second media content provider 18 is a second source, in addition to the first media content provider 16, for items of media content. As previously discussed, the first media content provider 16 may insert a second media content item provided by the second media content provider 18, into the first media content item, for example, in a designated content location. The second media content item, as inserted may include, or be associated with, metadata describing the contents of the second item of media content. For example, the second item of media content may include advertising content, whereupon the metadata may identify the advertisement. The metadata may include, e.g., one or more keywords representative of the content of the advertisement. For example, an advertisement from an automotive manufacturer may include keywords such car, truck, vehicle, driving, model names, keywords referring to performance parameters (fuel economy, horsepower), etc. As described in additional detail below, the second item of media content may include one or more segments, arranged sequentially, with segment level metadata associated with each segment. The segment level metadata may indicate characteristics of the particular media content segment and may include one or more keywords representative of the content of the segment.

The second media content provider 18 may provide the second media content item, including metadata, to the first content media provider 16. In this case, the first media provider 16 may insert segments of the second item of media content into, e.g., content locations provided within a first media content item, e.g., content locations provided for advertising. Alternatively, the second media content provider 18 may provide, e.g., only the metadata to the content provider 16. In this case, the first media content provider 16 may generate, e.g., links (e.g., using known mechanisms such as Uniform Resource Locators or the like) to the second item of media content such that the second item of media content is displayed during the provided content locations in the first item of media content.

The media device 12 is connected to or could include the display device 22. The display device 22 may be, for example, a television receiver, a monitor, a desktop computer, a laptop computer, a tablet, a mobile telephone, etc. The display device 22 may include one or more displays and one or more speakers for outputting respectively the video and audio portions of media content and advertisement content received from the media device 12.

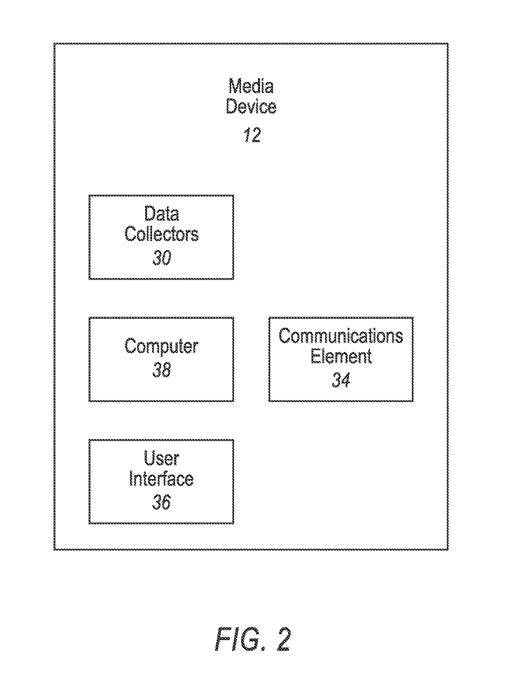

As shown in FIG. 2, the media device 12 includes one or more data collectors 30, a communications element 34, a user interface 36, and a computer 38. The computer 38 is communicatively coupled with each of the data collectors 30, communications element 34 and user interface 36.

The data collectors 30 may include, for example cameras, microphones, motion detectors, infrared sensors, ultrasonic sensors, and other types of sensors for collecting data regarding the users 24 and items 26 in the viewing area 20. The data collectors 30 are communicatively coupled to the computer 38, and may be included in or remote to the media device 12. The data collectors 30 may be used to collect visual images of the viewing area 20 and provide data to the computer 38 regarding the images. The visual images may include images of the users 24 and items 26 within the viewing area 20. As discussed below, the data collectors 30 may collect the visual images from the viewing area 20 at any time. In this manner, even when the media device 12 is not being used to display media content, the data collectors 30 may collect data regarding potential interests (and disinterests) of viewing area 20 users 24. This data may be stored, for example, in the memory associated with the media device 12, or other memory communicatively coupled with the media device 12 computer 38. The stored data may be accessed, for example, during viewing of a first media content item, and the data used, when applicable together with currently collected data, to select a second media content item or segment of a second media content item for display.

For example, the data regarding the potential interests may include one or more keywords associated with interests of the user. An indicia of interest may be associated with each keyword, indicating a level of interest of the user. The computing device may select keywords with an indicia of interest above a predetermined level, and compare these keywords with the keywords representative of the second media content item or segment of the second media content item. The second media content item or segment of the second media content item may be selected based on identifying a match between the selected keywords associated with the user and keywords representing the content of the second media content item or segment of the second media content item.

In some cases, the computing device may search for an exact match between the keyword indicating user interest and the metadata. For example, a keyword indicating user interest may be golf, and a keyword “golf” may be included in the metadata.

In other cases, a match between a keyword indicating user interest and the metadata may be indirect. For example, a keyword indicating an interest in skiing may be matched with a media content item related to vacations in the Swiss Alps.

The computing device, based on the determined match between keywords associated with interests of the user and keywords in the metadata may select and display the media content item during the viewing event.

The data collectors 30 may further be used to collect audio data from the viewing area 20 and provide the audio data to the computer 38. The audio data may include, e.g., speech from the users 24, and may further include, for example, sounds from pets 26, music played on other media devices, etc. As with the video data, the audio data may be collected from the viewing area 20 at any time. The audio data may be stored and accessed during a viewing event, to determine the interests of users 24.

Additionally, the data collectors 30 may be used to collect biometric data related to the users 24. For example, the data collectors 30 may track user eye movements, detect user pupil dilation, measure user heartrate, etc.

For example, a user 24 of the viewing area 20 may, at any time, express an interest in a Disney character Elsa during a conversation with a sibling. A data collector 30 may detect the information, and provide the information to the computer 38. The computer 38, may, via voice recognition techniques, as are known, determine that the user 24 likes Elsa, and store this information together with identity data such that the information is associated with the user 24. The computer 38 may further generate or modify an indicia of interest associated with the keyword based on the data.

As another example, a heartrate of a user 24 may increase when a particular subject (political figure, sports team, news event, etc.), appears or is discussed in a media content item.

As yet another example, data collectors 30 may be used to detect motion within the viewing area 20 and generate motion detection data. The motion detection data may be used, for example, to start the collection of data from other data collectors 30.

The communications element 34 may include hardware, software and firmware components such as are known to receive media data from one or more media content providers 16, 18.

The user interface 36 may include one or more input elements such as buttons, a key board, a touchscreen, a roller ball, a touchscreen, a mouse, a microphone, switches, etc. for receiving input from a user. The user interface 36 may further include one or more display elements such as an LCD display, plasma display, speaker, lamps, light emitting diodes, buzzers, etc. for outputting data to the user. The user may be, e.g., a user 24 of the viewing area 20.

The computer 38 includes a memory, and one or more processors, the memory storing program code, i.e., computer-executable instructions, executable by the processor. The computer 38 is operable to receive media content from the media content providers 16, 18, and display received media content on the display device 22.

Additionally, the computer 38 is programmed to collect data regarding the viewing area 20, users 24 and items 26. The data may be collected, via, e.g., the data collectors 30. The collected data may include, e.g., data which may be useful for selecting media content segments for insertion into a first media content item being viewed by one or more users 24 of the viewing area 20.

During the viewing event, the computer 38 is further programmed to collect data regarding the viewing area 20, users 24 and items 26 in the viewing area 20. Based on the collected data, the computer 38 may determine characteristics and interests regarding the users 24 which may be used to select second media content item segments to present to the users 24. For example, the computer 38 may detect a user playing with a pet, detect a hockey trophy in the viewing area 20, detect a user eating pizza, etc. Further, the data may be used to identify users 24, and to retrieve and use additional user data to determine characteristics and interests of the users 24. The data used to identify the user 24 may be, e.g., facial features, body size and shape, sound of the user's voice, eye color, etc. which can be used to identify a user. The retrieved data may be, for example, records of previous conversations of the user indicating an interest in a topic, articles in the user's possession at a previous time (tools, sports equipment, books, etc.), which may indicate interests of the user 24.

Based on the determined characteristics of the users 24, the computer 38 may recommend, e.g., to the media content provider 16 or 18, media content or a segment thereof, to display to the one or more users 24. Further, during the display of a first segment of a media content item, the computer 38 may collect data regarding the users 24, and based on, for example, reactions of the viewers to the first segment, recommend a subsequent segment or segments of the items of media content. The computer 38 may continue to collect data regarding the users 24 during the display of the item of media content, and continue, on an on-going basis, to recommend adjustments to the media content item based on the collected data. The computer 38 may additionally continue to update user data based on data collected during the display of media content. Updating the user data may include associating keywords with areas of potential interest of the user, and generating/updating indicia of interest associated with the keywords.

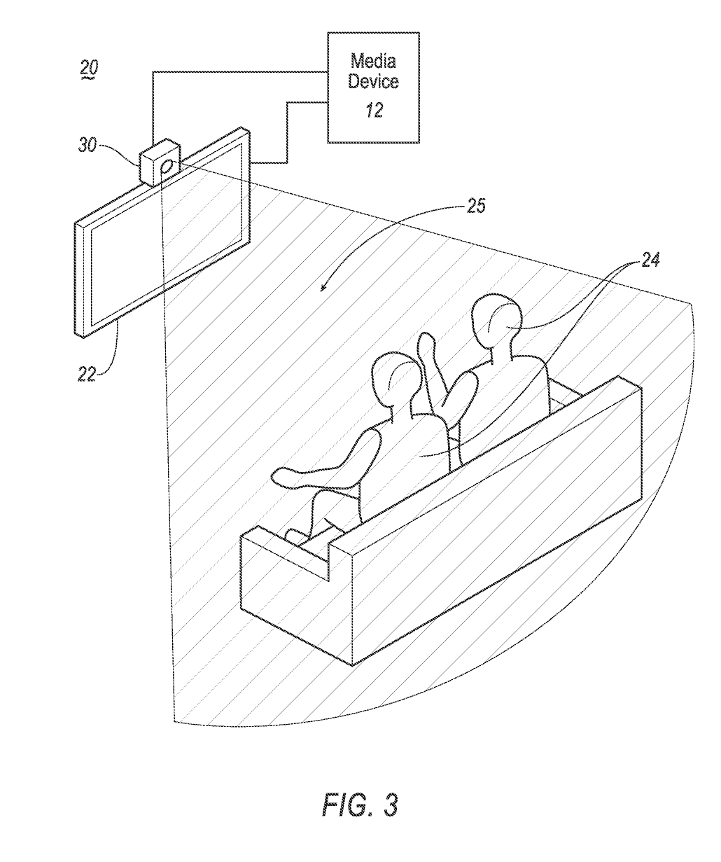

The computer 38 may further, based on data from the data collectors 30, determine whether a user 24 is within a range to view the display device 22. As shown in FIG. 3, a data collector 30 may be a camera with a field of view 25. The camera may be positioned, for example, on the display device 22 such that the field of view 25 corresponds with a range in which users 24 can view the display device 22. In this manner, the data collectors 30 may determine a number of users 24 within a range to view the display device 22. In case the field of view 25 of a single camera is not sufficient, additional cameras may be used to detect users within a determined viewing range of the display device 22.

The first media content provider 16 and/or second media content provider 18 may provide media content to the media device 12 for display on the display device 22. In some cases, the media provider 16 may receive the second media content item from the second media content provider 18. The second media content item may include metadata associated with the second media content. The first media content provider 16 may, e.g., during the streaming of media content to the media device 12, insert the second media content item into content locations designated for the second media content item. The content locations may be of a fixed or variable length.

In other cases, the first media content provider 16 may receive only metadata associated with the second media content item, and provide a link or the like to the second media content. The media provider 16 may, based on the metadata, access an address or the like indicated in the link to provide selected second media content to the media device 12.

The computer 38 may adjust the second media content item, based on recommendations received from the media device 12. The adjustment may occur prior to displaying the second media content item, or dynamically, during display of the second media content item. As an example, during a first segment of the second media content item for a vehicle manufacturer, a user 24 may express (e.g., in a conversation), an interest in a particular model vehicle from the vehicle manufacturer. The media device 12 may detect keywords in the conversation using known voice recognition techniques, e.g., a vehicle brand and model, and, based on this detected user data, recommend to the first media content provider 16 and/or second media content provider 18 to provide a second media content item or segment that references on the model vehicle in which the user 24 expressed an interest.

Media content may be generated to support the dynamic adjustment of the second media content item during display. For example, the second media content item may be organized as a series of segment locations. One or more segments of second media content may be generated for each segment location. Alternate segments of second media content for a particular segment location may focus on, e.g., different characteristics of a manufacturer's product offerings. By way of example, and not limitation, the different characteristics may relate to different features (of, e.g., a product), target audience (adults, children, football fans, dog owners), character (e.g., favorite Disney character), activity, geographic area, etc. The characteristics may be communicated to the media provider 16 via segment level metadata associated with the second media content item.

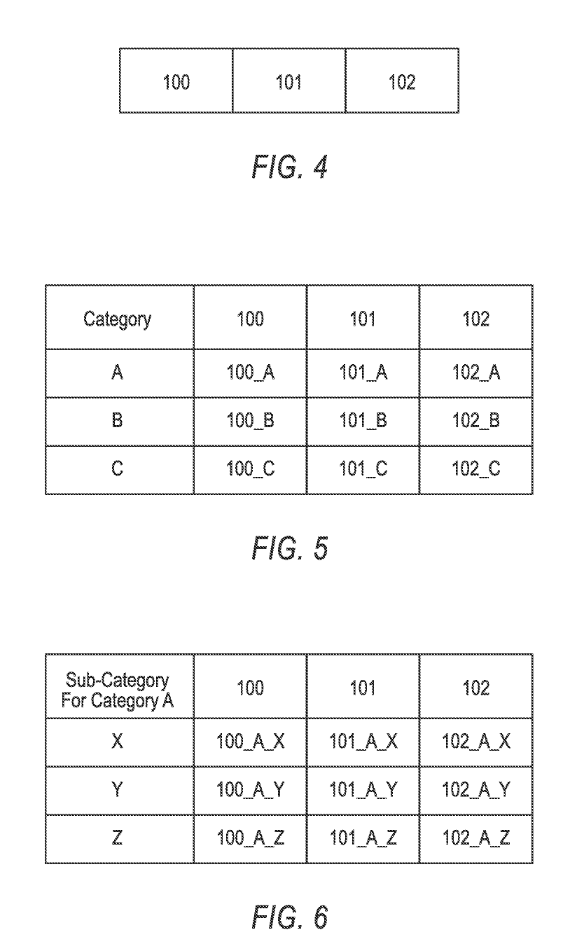

As an example, as shown in FIG. 4, a second media content item may be organized as first, second and third segment locations 100, 101, 102. The second media content item may be, for example, for a vehicle manufacturer. Although the example of FIG. 4 is based on three segments locations, the second media content item may be organized as any number of segment locations. Different segment locations may have different lengths. For example, segment 100 may be 10 seconds long (i.e., the segment location may be intended to receive segments with a playback duration of 10 seconds), and segment location 101 may be 15 seconds long. Additionally, the segment locations do not need to be fixed in length. For example, the length of the segment location 102 may vary from 5 seconds in length to 15 seconds in length, depending on the content that is selected to be displayed within that segment location.

The second media content item may include sets of segments to be inserted in respective segment locations. For example, referring to FIG. 5, the second media content item may be organized to address first, second and third categories A, B, C. The first category may be, for example, general information related to characteristics of the manufacturer's brand, e.g., overall quality, design, and performance of the manufacturers products. Category B may be focused on trucks and category C may be focused on automobiles. Each category may have a second media content item segment for each segment location.

The second media content item may include additional segments that are more narrowly targeted. As shown in FIG. 6, the category A may include first, second and third sub-categories x, y, z. Category x may include, for example, second media content item segments focused on product quality. Category y may include, for example, segments focused on product design. Category z may include segments focused on performance.

Similarly, for example, category B could be further divided to include sub-categories representing three different models of trucks, and category C could be further divided to include sub-categories representing three different models of automobiles.

Additional levels of segmentation may also be implemented.

Prior to, and during the display of the second media content item, the media device 12 computer 38 may collect data regarding the users 24 in the viewing area 20. The computer 38 may provide the collected data to the first media content provider 16 and/or second media content provider 18. Based on the characteristics and interests determined from the data, the first media content provider 16, and/or the second media content provider 18 may select categories and sub-categories of the second media content item to display to the users 24.

The media device 12 may provide raw data, i.e., data directly from the data collectors 30, to the first media content provider 16 and/or second media content provider 18. Additionally or alternatively, the media device 12 may analyze the data, and provide results of the analysis to the first media content provider 16 and/or second media content provider 18. The media device 12 may, e.g., determine characteristics and interests of the user(s) 24 (e.g., adults, adults and children, dog owner, hockey player, currently planning a family vacation, etc.).

Based on the data provided by the media device 12, the first media content provider 16 and/or second media content provider 18 may select segments of the second media content item which align with the characteristics and interests of the users 24. As described above, the data may include keywords associated with areas of interest, and may further include indicia of interest associated with the keywords.

### Processes

### Collecting Data Related to Users at the Viewing Area

As indicated above, a media device 12 computer 38 located in a viewing area 20 may be programmed to collect data related to the users 24 of the viewing area 20. The media device 12 may, for example, collect data continuously, during times when the media device 12 is displaying a first media content item or a second media content item, and also during times when the media device 12 is not displaying any type of content (e.g., the display is turned-off). The data collected by the media device 12 computer 38 may include visual and audio data.

Visual data may include, for example, identifying characteristics of the users 24 such as body size and shape, facial features, eye color, etc. which would allow the computer 38, using image recognition techniques as are known, to identify a user 24. Visual data may further include behaviors of the users 24 such as facial expressions, body language, movements, heartrate, eye movement, pupil dilation, etc. Still further, visual data may include items 26 such as clothing worn by the user 24, objects carried or held by the user 24, objects in the room, pets, etc.

Audio data may include, for example, conversations conducted by the users 24, expressions of surprise, laughter, music (performed or played from, e.g., a laptop computer), sounds of pets in the viewing area 20, etc.

The data collected by the media device 12 may be stored. Users 24 may be identified based on physical appearance, facial features, voice quality, etc., and assigned, for example, an identification number. The media device 12 computer 38 may associate conversations with the identified users 24. Additionally or alternatively, the media device 12 computer 38 may associate items 26 with the identified users 24.

For example, the media device 12 data collector 30 may detect speech from a user 24 indicating interest in, e.g., a particular professional hockey team. The media device 12 computer 38 may analyze the speech, using voice recognition techniques as are known, and determine that the particular user 24 is generally interested in professional hockey, and particularly interested the identified hockey team.

As another example, the media device 12 computer 38 may collect visual data, e.g., using captured camera images and known image recognition techniques, indicating that a user 24 is drinking a specific type of drink, e.g., a sports drink. The media device 12 may determine that the user 24 is a consumer of sports drinks, and may further identify, for example, a particular type of sports drink, flavor of sports drink, etc., that the user 24 was consuming (and may prefer).

During the display of, e.g., the second media content item, the media device 12 computer 38 may additionally collect data indicating the reaction of users 24 to the second media content item.

When the second media content item starts (e.g., during the first segment of the media content item), the media device 12 computer 38 may listen (via the data collector 30) for commentary. For example, a user 24 may comment, upon seeing the beginning of a second media content item about Disney products, that the user 24 really likes Elsa. As another example, a user 24 may comment, upon seeing a second media content item about an automobile manufacturer, that the user 24 really likes a particular type of truck. The computer 38 may receive audio data including these comments, and associate these comments with the respective users 24.

The computer 38 may further receive visual data. For example, during display of the second media content item, the computer 38 may receive the visual data indicating that a particular user 24 is watching intently, is smiling, stops paying attention, or walks out of the viewing area 20. Based on the data, the computer 38 may infer more or less interest on the part of the user 24 in particular segments of the second media content item.

As described above, the computer 38 may assign keywords to areas of interest associated with the users, and may further assign indicia of interest to the keywords, wherein the indicia of interest reflect an inferred level of interest of the user in the area of interest associated with the keyword.

### Storing User Data

The media device 12 computer 38 may store data related respectively to one or more users 24. The user data may include identifying data sufficient to identify a particular user 24 collected from the data collectors 30. For example, the identifying data may include body size, body shape, facial features, and voice features sufficient to uniquely identify a user 24, based on known image recognition techniques.

The user data may further include data regarding the actions, speech of the user 24. The data may be, for example, raw data, such as video and audio data received respectively from the data collectors 30, along with a time stamp.

The user data may further be interpreted data. For example, the computer 38 may, based on known image and voice recognition techniques, determine, that, e.g., the user 24 frequently plays with a particular doll, reads books, picks up a pet, speaks about cooking, etc.

Based on the user data, the computer 38 may further determine apparent likes and dislikes of the user 24. The computer 38 may determine, for example, based on visual data (playing with an Elsa doll, paying attention to Elsa advertisements) and audio data (speaking about Elsa), that a particular user 24 really likes the Disney character Elsa and is attracted to products related to Elsa. As another example, the computer 38 may determine that a user 24 enjoys both playing and watching golf. As described above, the computer 38 may assign keywords to the areas of interest of the user, and generate indicia of interest indicating a level of inferred interest of the user in the area of interest.

The raw and/or interpreted data may be stored in a memory included in or communicatively coupled with the computer 38. As new data is received, the computer 38 may update the user data. In this manner, the computer 38 may develop, over time, data indicating the probable likes and dislikes of users 24 of the viewing area 20.

### Characterizing Users During a Viewing Event

The media device 12 computer 38 may characterize one or more users 24 of the viewing area 20 during a viewing event. In this context, “characterize” means to determine data values for one or more attributes of a user 24, e.g., a gender, age (or age range), an interest or interests (e.g., cars, football, ice skating, Shakespeare, etc.). For example, as mentioned above, the device 12 may use image recognition, speech recognition, and/or other techniques to determine user 24 attributes.

That is, as described above, the media device 12 computer 38 may collect visual and audio data related to the users 24 during the viewing event. Based on the data, the computer 38 may determine, for example, a number of adults and a number of children in a range to view the display device 22. As described above, the computer 38 may further make some inferences about interests, based, e.g., on conversations and items 26 associated with the one or more users 24. The computer 38 may generate and or update keywords indicating interests of the user, and indicia of interest associated with the keywords.

The computer 38 may yet further, based on the collected data, associate a user 24 during the viewing event with previously stored user data. The computer 38 may retrieve additional information regarding likely interests of the user 24 from the user data.

Based on the data (currently collected and/or retrieved user data), the computer 38 may develop a characterization that applies to two or more users 24 collectively. For example, the computer 38 may determine that the users 24 are all children, a mix of adults and children. The computer 38 may further determine, for example, that two or more of the users 24 like to participate in a particular type of activity (riding a bicycle, cooking, gardening, etc.). The characterization may include keywords which apply to two or more of the users, and may further include, e.g., an indicia of interest for each keyword, wherein the indicia of interest is based on the individual indicia of interest for each of the one or more users. For example, an indicia of interest associated with a keyword for a group of people may be the average of the indicia of interest for that keyword for each individual in the group.

### Selecting a Media Content Item Based on User Characteristics

Based on characteristics of one or more users 24, a computing device, e.g., the computer 38, a computing device associated with the first media content provider 16, a computing device associated with the second media content provider 18, etc., may select a media content item to display to the users 24 during a viewing event.

The computing device may initially, for example, determine whether the media content item should target a particular age group, an age group being one possible user 24 characteristic. For example, the computing device may determine that none of the users 24 are children, and that the media content item should include content likely to be of interest to adults.

The computing device may further, select the media content item based on likely interests of the users 24 during the viewing event. For example, in the case that the media device 12 computer 38 determines that two or more of the users 24 have expressed an interest in cycling, the computing device may select a cycling related media content item. Determining that a group of two users has an interest in cycling may include, for example, that the keyword cycling is associated with each of the two users, and that the average indicia of interest for cycling for the two users is greater than a predetermined value, e.g., 70.

As described above, a particular media content item may include sub-segments focused on particular products. For example, if, more specifically, the users 24 expressed an interest in mountain bikes, the computing device may display sub-segments of the media content item with an emphasis on mountain bikes.

The computing device may select the media content item or sub-segments of the media content item, by matching keywords indicating interests of the users 24 with metadata included with the media content item. The keywords indicating interest for each of the users may be, e.g., keywords with an associated indicia of interest greater than a predetermined value.

In some cases, the computing device may search for an exact match between the keywords indicating interest and the metadata. For example, a keyword indicating user interest may be golf, and a tag “golf” may be included in the metadata.

In other cases, a match between a keyword indicating interest and the metadata may be indirect. For example, a keyword indicating an interest in skiing may be matched with a media content item related to vacations in the Swiss Alps.

The computing device, based on the determined match between keywords indicating user interests (and other characteristics) and metadata, may select and display the media content item during the viewing event.

### Dynamically Adjusting the Media Content Item Based on User Reactions

A computing device, e.g., the computer 38, a computing device of the first media content provider 16, a computing device of the second media content provider 18, etc., may further determine a reaction of a user 24 (or two or more users 24) to a segment of a second media content item, and select a subsequent segment based on the reaction.

As an example, a second media content item may be developed to encourage tourism in France. While watching an initial segment, a user 24 of the viewing area 20 might say that she would love to go on a wine tasting cruise. The media device 12 data collector 30 may provide audio data reflecting this comment to the computer 38. The computer 38 (or another computing device communicatively coupled with the computer 38), may, using known voice recognition techniques, determine that the user 24 expressed an interest in a wine tour. Based on this determination, the computing device may select subsequent segments of the second media content item to focus on wine tasting cruises available in France.

In some cases, the second media content items, as described above, may have additional levels of customization. For example, in the case described above, the user 24 (or another user 24), during the subsequent segments of the media content item may say that he or she really enjoys French cooking. The computing device may select following segments of the second media content item to focus on the dining experience associated with a wine tasting cruise.

Dynamically adjusting the second media content item may include adjusting the length (e.g., increasing/decreasing content to achieve a longer/shorter duration of playback) of the second media content item. For example, the second media content provider 18 may supply, for a particular segment location 102 (FIG. 3) both a long sub-segment and a short sub-segment. In the case that one or more of the users 24 is expressing a high level of interest in the second media content item, the computing device may select the long sub-segment. There may be multiple sub-segments for the segment location 102 of different lengths, and the computing device may select a length of sub-segment corresponding to a perceived level of interest by the users 24. Additionally or alternatively, second media content provider 18 may provide additional segments of content, and the computing device may be programmed to extend the second media content item to include one or more additional segments.

The computing device may further be programmed to, for example, lengthen the total display time for the viewing event to accommodate the longer second media content item. Additionally or alternatively, the computing device may be programmed to remove some content from the first media content item, shorten or eliminate another second media content item, etc., to accommodate the longer second media content item.

For example, in the example above, the computer 38 may determine, via the data collector 30 that one or more users 24 are in the range to view the display device 22 and are watching the segments regarding the dining experience during a wine tasting cruise intently. Based on this determination, the computer 38, or another computing device communicatively coupled with the computer 38, may insert additional segments (or longer segments) into the second media content item, with additional information about restaurants available during the wine tasting cruise, or about an alternate tour of France focused on exploring restaurants.

Conversely, in the case that one or more users 24 express a dislike or disinterest in a particular second media content item, the second media content item could be shortened, and the remaining time used to, e.g., display an alternate second media content item.

In this manner, the second media content item can be dynamically adjusted according to the reaction of users 24 to initial segments of the second media content item.

The computer 38 may also, based on user 24 reactions to the second media content item, or segments of the second media content item, update the stored data related to the users 24.

Note that the example of selecting and dynamically adjusting a second media content item (e.g., an advertisement) during the display of a first media content item (e.g., a movie or live broadcast), is intended to be exemplary and not limiting. In some cases, for example, the system 10 may display a single media content item, and adjust the single media content item based on user 24 characteristics.

Providing Feedback to the First and/or Second Content Providers

The computer 38 may, e.g., upon completing the display of the second media content item, report data related to the second media content item to the first media content provider 16, the second media content provider 18 or other computing device. The data related to the second media content item may include when the second media content item was presented, which segments were presented, a length of the second media content item (measured, e.g., in seconds), a number of users 24 present in the viewing area during the second media content item, a number of positive reactions of users 24 that were detected during the display of the second media content item, etc. This data may be used, e.g., to adjust billing. For example, the first media content provider 16 may charge the second media content provider 18 a fixed rate per second to display the second media content items. The charge for displaying the second media content item may be adjusted based on the second media content item's length. As another example, the cost of the second media content item may be adjusted based on a number of users 24 detected in the range to view the display device 22 during display of the second media content item.

### Example Process

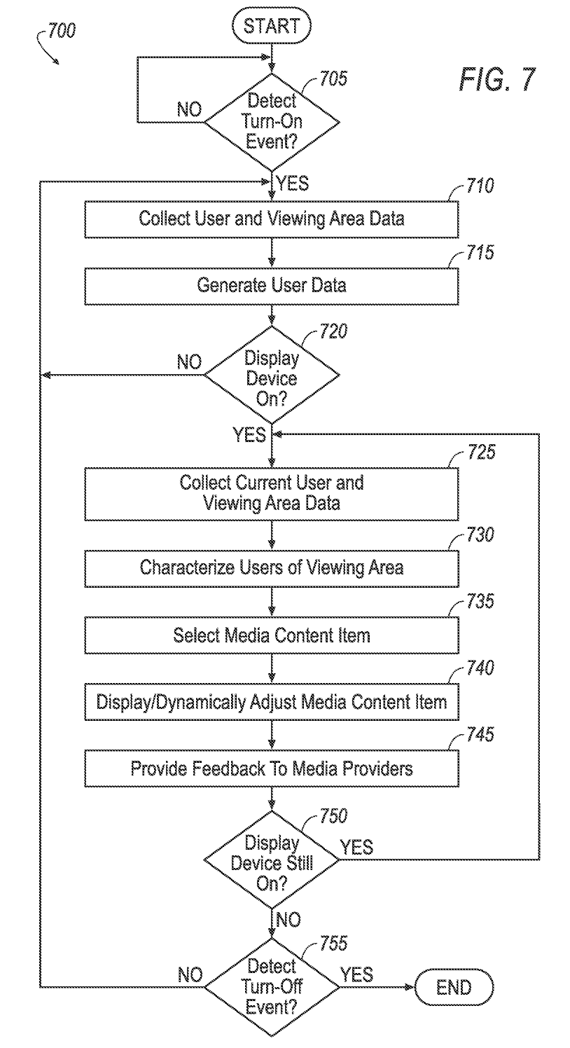

FIG. 7 is a diagram of an exemplary process 700 for adjusting, by a computing device, the content of a second media content item based on at least one characteristic of at least one user 24 of a viewing area 20 where the second media content item is displayed. The process 700 starts in a block 705.

In the block 705, the computer 38 of the media device 12, determines whether a turn-on event has occurred. For example, a user, who may be a user 24 of the viewing area 20, may push a power button on the media device 12 interface 36. Alternatively, a turn-on event may include determining that the media device 12 is plugged in, and receiving power.

As another alternative, the turn-on event may be the detected presence of a user 24 in the viewing area 20. For example, the media device 12 may include a motion detector which may be powered independently from other portions of the media device 12. The motion detector may detect motion in the viewing area 20. Upon detecting motion, the motion detector may activate the media device 12 computer 38.

As another alternative, the turn-on event for the process 700 may include receipt of an authorization to collect data from the viewing area 20. For example, the computer 38 may be programmed to collect data only upon receiving authorization. A user may provide an input, e.g., a passcode or the like, to the computer 38 indicating that the computer is authorized to collect data. Upon detection of a turn-on event by the computer 38, the process 700 continues in a block 710.

In the block 710, the computer 38 may collect data regarding the viewing area 20, user(s) 24 of the viewing area 20 and items 26 in the viewing area 20 as described above. Upon having collected data, the process 700 continues in a block 715.

In the block 715, the computer 38 generates and/or updates user data related to one or more users 24, as described above. Upon having stored and/or updated the user data, the process 700 continues in a block 720.

In the block 720, the computer 38 determines whether the display device 22 is on, e.g., that media device 12 is displaying media content on the display device 22. In the case that the media device 12 is displaying content on the display device 22, the process 700 continues in a block 725. In the case that the media device 12 is not displaying content on the display device 22, the process 700 continues in the block 710.

In the block 725, the computer 38 collects data with regard to one or more users 24 of the viewing area 20 during the viewing event. The computer 38 collects visual and audio data as described above. The computer 38 may further, based on the collected data, associate the one or more users 24 during the viewing event with previously stored user data. The computer 38 may retrieve additional information, e.g., information regarding likely interests of the one or more users 24, from the stored user data. As described above, the data may include keywords indicating areas of interest of the user, and may further include indicia of interest associated with the keywords. After the computer 38 has collected data regarding the users 24, the process 700 continues in a block 730.

In the block 730, the computer 38 characterizes the one or more users 24 of the viewing area 20 during a viewing event. As described above, the computer 38 may characterize individual users 24 of the viewing area 20, i.e., determine attributes that pertain to an individual user 24, in addition to determining attributes pertaining to two or more users 24. The computer 38 may further develop a characterization of a group of users 24 in the viewing area 20 during the viewing event. For example, the computer 38 may determine that the group includes only adults, or both adults and children. The computer 38 may further make determinations about interests of the group. For example, the computer 38 may determine that two or more of the users 24 of the viewing area 20 have shown an interest in football. The computer 38 may additionally update the profiles for the users 24. For example, the computer 38, may assign a keyword football to each of the two or more users, and may further assign an indicia of interest to the keyword respectively for each of the two or more users. The process 700 continues in a block 735.

In the block 735, as described above, a computing device, for example, the media device 12 computer 38, the media provider 16 computing device, the advertisement provider 18 computing device, etc., selects a second media content item for display. The process 700 continues in a block 740.

In the block 740, the computer 38 displays the selected second media content item. As described above, the computer 38 collects data regarding the reactions of the one or more users 24 of the viewing area 20. Based on the reactions, the computer 38 may adjust subsequent segments of the second media content item. The computer 38 may further update the user data associated with respective users 24. Additionally, the computer 38 may determine the number of users 24 in the range to view the display device 22. When the computer 38 has completed the presentation of the second media content item and updated the user data, the process 700 continues in a block 745.

In the block 745, the computer 38 may report data to, for example, the first media content provider 16 computing device and/or the second media content provider 18 computing device regarding the second media content item. As described above, the data may include when the second media content item was presented, which segments were presented, a length of the second media content item (measured, e.g., in seconds), a number of users 24 in the range to view the display device 22 during display of the second media content item, a number of positive reactions of users 24 that were detected during the display of the second media content item, etc. When the computer 38 has reported the data, the process 700 continues in a block 750.

In the block 750, the computer 38 determines whether the viewing event is on-going. In the case that the viewing event is on-going, the process 700 continues in a block 725. In the case that the viewing event is over, i.e., the process 700 continues in a block 755.

In the block 755, the computer 38 determines whether a turn-off event has occurred. A turn-off event may be, for example, the computer 38 receives an input from a user via the user interface 36 requesting that the media device 12 be turned-off. A turn-off event may further be, for example, that power is turned off for the media device 12 or a portion of the media device 12. A turn-off event may further be, for example, that the computer 38 receives an input from the user via the user input indicating that the computer 38 should stop collecting data. Still further, a turn-off event may be the detection, e.g., by a motion detector, that there are no users 24 in the viewing area 20. In the case that the computer 38 determines that no turn-off event has occurred, the process 700 continues in the block 710. In the case that the computer 38 determines that a turn-off event has occurred, the process 700 ends.

### CONCLUSION

As used herein, the adverb “substantially” means that a shape, structure, measurement, quantity, time, etc. may deviate from an exact described geometry, distance, measurement, quantity, time, etc., because of imperfections in materials, machining, manufacturing, etc.

The term “exemplary” is used herein in the sense of signifying an example, e.g., a reference to an “exemplary widget” should be read as simply referring to an example of a widget.

Networked devices such as those discussed herein generally each include instructions executable by one or more networked devices such as those identified above, and for carrying out blocks or steps of processes described above. For example, process blocks discussed above may be embodied as computer-executable instructions.

Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a networked device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

1. A system comprising:
a media device including a processor and a memory, the memory storing instructions executable by the processor such that the processor is programmed to:
display a first media content item on a display device;
collect sensor data, during display of the first media content item, related to one or more users determined to be in a range to view the display device;
select a second media content item based at least in part on the sensor data; and
insert the second media content item into the display of the first media content item.

2. The system of claim 1, wherein the processor is further programmed to:
use the sensor data to generate one or more indicia of interest associated with one or more respective keywords, wherein selecting the second media content item is based at least in part on the keywords.

3. The system of claim 2, wherein the data includes at least one of audio data and visual data, and the keywords are based at least in part on the at least one of audio data and visual data.

4. The system of claim 3, wherein the audio data includes speech from the one or more users.

5. The system of claim 3, wherein the visual data includes data related to objects in the range to view the display device.

6. The system of claim 1, wherein the processor is further programmed to:
collect sensor data prior to providing the display.

7. The system of claim 6, wherein the processor is further programmed to:
use the sensor data collected prior to the display of the first item of media content in selecting the second media content item.

8. The system of claim 2, wherein the processor is further programmed to:
compare a keyword representative of interests of at least one of the one or more users with metadata for the second item of media content, the keyword representative of interests being determined from the collected sensor data.

9. The system of claim 2, wherein the processor is further programmed to:
determine a keyword representative of interest related to two or more users from the collected sensor data; and
compare the keyword representative of interest related to the two or more of users with the metadata for the second media content.

10. The system of claim 1, wherein the processor is further programmed to:
collect data related to the one or more users during a first portion of the second item of media content item; and
select a second portion of the second media content item based at least in part on the data related to the one or more users during the first portion of the second media content item.

11. The system of claim 1, wherein the processor is further programmed to:
collect data related to the one or more users during a first portion of the second media content item; and
adjust a length of the second media content item based at least in part on the data collected during the first portion of the media content item.

12. The system of claim 11, wherein the processor is further programmed to:
provide to at least one of a first media content provider, a second media content provider and another computing device, input related to the length of the second media content item.

13. A method comprising:
displaying, by a processor in a media device, a first media content item on a display device;
collecting sensor data, during display of the first media content item, related to one or more users determined to be in a range to view the display device;
selecting a second media content item based at least in part on the sensor data; and
inserting the second media content item into the display of the first media content item.

14. The method of claim 13, further comprising:
using the sensor data to generate one or more indicia of interest associated with one or more respective keywords, wherein selecting the second media content item is based at least in part on the keywords.

15. The method of claim 14, wherein the data includes at least one of audio data and visual data, and the keywords are based at least in part on the at least one of audio data and visual data.

16. The method of claim 13, further comprising:
collecting sensor data prior to providing the display, and.
using the sensor data collected prior to the display of the first item of media content in selecting the second media content item.

17. The method of claim 14, further comprising:
comparing a keyword representative of interests of at least one of the one or more users with metadata for the second item of media content, the keyword representative of interests being determined from the collected sensor data.

18. The method of claim 14, further comprising:
determining a keyword representative of interest related to two or more users from the collected sensor data; and
comparing the keyword representative of interest related to the two or more of users with the metadata for the second media content.

19. The method of claim 13, further comprising:
collecting data related to the one or more users during a first portion of the second item of media content item; and
selecting a second portion of the second media content item based at least in part on the data related to the one or more users during the first portion of the second media content item.

20. The method of claim 13, further comprising:
collecting data related to the one or more users during a first portion of the second media content item;
adjusting a length of the second media content item based at least in part on the data collected during the first portion of the media content item; and
providing to at least one of a first media content provider, a second media content provider and another computing device, input related to the length of the second media content item.
